(19) United States
(12) Patent Application Publication
(10) Pub. No.: US 2010/0083247 A1
(43) Pub. Date: Apr. 1, 2010

(54) System And Method Of Providing Multiple Virtual Machines With Shared Access To Non-Volatile Solid-State Memory Using RDMA

(75) Inventors: Arkady Kanevsky, Swampscott, MA (US); Steven C. Miller, Livermore, CA (US)

Correspondence Address: Perkins Coie LLP, P.O. Box 1208, Seattle, WA, 98111-1208, US

(73) Assignee: NetApp, Inc., Sunnyvale, CA (US)

(21) Appl. No.: 12/239,092

(22) Filed: Sep. 26, 2008

(51) Int. Cl. G06F 9/455; G06F 12/00; G06F 13/28; G06F 9/54

(52) U.S. Cl. 718/1; 710/22; 711/114; 719/312; 711/E12.001

(57) ABSTRACT

A processing system includes a plurality of virtual machines which have shared access to a non-volatile solid-state memory (NVSSM) subsystem, by using remote direct memory access (RDMA). The NVSSM subsystem can include flash memory and other types of non-volatile solid-state memory. The processing system uses scatter-gather lists to specify the RDMA read and write operations. Multiple reads or writes can be combined into a single RDMA read or write, respectively, which can then be decomposed and executed as multiple reads or writes, respectively, in the NVSSM subsystem. Memory accesses generated by a single RDMA read or write may be directed to different memory devices in the NVSSM subsystem, which may include different forms of non-volatile solid-state memory.

### FIELD OF THE INVENTION

At least one embodiment of the present invention pertains to a virtual machine environment in which multiple virtual machines share access to non-volatile solid-state memory.

### BACKGROUND

Virtual machine data processing environments are commonly used today to improve the performance and utilization of multi-core/multi-processor computer systems. In a virtual machine environment, multiple virtual machines share the same physical hardware, such as memory and input/output (I/O) devices. A software layer called a hypervisor, or virtual machine manager, typically provides the virtualization, i.e., enables the sharing of hardware.

A virtual machine can provide a complete system platform which supports the execution of a complete operating system. One of the advantages of virtual machine environments is that multiple operating systems (which may or may not be the same type of operating system) can coexist on the same physical platform. In addition, a virtual machine and have instructions that architecture that is different from that of the physical platform in which is implemented.

It is desirable to improve the performance of any data processing system, including one which implements a virtual machine environment. One way to improve performance is to reduce the latency and increase the random access throughput associated with accessing a processing system's memory. In this regard, flash memory, and NAND flash memory in particular, has certain very desirable properties. Flash memory generally has a very fast random read access speed compared to that of conventional disk drives. Also, flash memory is substantially cheaper than conventional DRAM and is not volatile like DRAM.

However, flash memory also has certain characteristics that make it unfeasible simply to replace the DRAM or disk drives of a computer with flash memory. In particular, a conventional flash memory is typically a block access device. Because such a device allows the flash memory only to receive one command (e.g., a read or write) at a time from the host, it can become a bottleneck in applications where low latency and/or high throughput is needed.

In addition, while flash memory generally has superior read performance compared to conventional disk drives, its write performance has to be managed carefully. One reason for this is that each time a unit (write block) of flash memory is written, a large unit (erase block) of the flash memory must first be erased. The size of the erase block is typically much larger than a typical write block. These characteristics add latency to write operations,. Furthermore, flash memory tends to wear out after a finite number of erase operations.

When memory is shared by multiple virtual machines in a virtualization environment, it is important to provide adequate fault containment for each virtual machine. Further, it is important to provide for efficient memory sharing by virtual machines. Normally these functions are provided by the hypervisor, which increases the complexity and code size of the hypervisor.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1A illustrates a processing system that includes multiple virtual machines sharing a non-volatile solid-state memory (NVSSM) subsystem;

FIG. 1B illustrates the system of FIG. 1A in greater detail, including an RDMA controller to access the NVSSM subsystem;

FIG. 1C illustrates a scheme for allocating virtual machines' access privileges to the NVSSM subsystem;

FIG. 2A is a high-level block diagram showing an example of the architecture of a processing system and a non-volatile solid-state memory (NVSSM) subsystem, according to one embodiment;

FIG. 2B is a high-level block diagram showing an example of the architecture of a processing system and a NVSSM subsystem, according to another embodiment;

FIG. 3A shows an example of the architecture of the NVSSM subsystem corresponding to the embodiment of FIG. 2A;

FIG. 3B shows an example of the architecture of the NVSSM subsystem corresponding to the embodiment of FIG. 2B;

FIG. 4 shows an example of the architecture of an operating system in a processing system;

FIG. 5 illustrates how multiple data access requests can be combined into a single RDMA data access request;

FIG. 6 illustrates an example of the relationship between a write request and an RDMA write to the NVSSM subsystem;

FIG. 7 illustrates an example of the relationship between multiple write requests and an RDMA write to the NVSSM subsystem;

FIG. 8 illustrates an example of the relationship between a read request and an RDMA read to the NVSSM subsystem;

FIG. 9 illustrates an example of the relationship between multiple read requests and an RDMA read to the NVSSM subsystem;

FIGS. 10A and 10B are flow diagrams showing a process of executing an RDMA write to transfer data from memory in the processing system to memory in the NVSSM subsystem; and

FIGS. 11A and 11B are flow diagrams showing a process of executing an RDMA read to transfer data from memory in the NVSSM subsystem to memory in the processing system.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment; however, neither are such occurrences mutually exclusive necessarily.

A system and method of providing multiple virtual machines with shared access to non-volatile solid-state memory are described. As described in greater detail below, a processing system that includes multiple virtual machines can include or access a non-volatile solid-state memory (NVSSM) subsystem which includes raw flash memory to store data persistently. Some examples of non-volatile solid-state memory are flash memory and battery-backed DRAM. The NVSSM subsystem can be used as, for example, the primary persistent storage facility of the processing system and/or the main memory of the processing system.

To make use of flash's desirable properties in a virtual machine environment, it is important to provide adequate fault containment for each virtual machine. Therefore, in accordance with the technique introduced here, a hypervisor can implement fault tolerance between the virtual machines by configuring the virtual machines each to have exclusive write access to a separate portion of the NVSSM subsystem.

Further, it is desirable to provide for efficient memory sharing of flash by the virtual machines. Hence, the technique introduced here avoids the bottleneck normally associated with accessing flash memory through a conventional serial interface, by using remote direct memory access (RDMA) to move data to and from the NVSSM subsystem, rather than a conventional serial interface. The techniques introduced here allow the advantages of flash memory to be obtained without incurring the latency and loss of throughput normally associated with a serial command interface between the host and the flash memory.

Both read and write accesses to the NVSSM subsystem are controlled by each virtual machine, and more specifically, by an operating system of each virtual machine (where each virtual machine has its own separate operating system), which in certain embodiments includes a log structured, write out-of-place data layout engine. The data layout engine generates scatter-gather lists to specify the RDMA read and write operations. At a lower-level, all read and write access to the NVSSM subsystem can be controlled from an RDMA controller in the processing system, under the direction of the operating systems.

The technique introduced here supports compound RDMA commands; that is, one or more client-initiated operations such as reads or writes can be combined by the processing system into a single RDMA read or write, respectively, which upon receipt at the NVSSM subsystem is decomposed and executed as multiple parallel or sequential reads or writes, respectively. The multiple reads or writes executed at the NVSSM subsystem can be directed to different memory devices in the NVSSM subsystem, which may include different types of memory. For example, in certain embodiments, user data and associated resiliency metadata (such as Redundant Array of Inexpensive Disks/Devices (RAID) data and checksums) are stored in flash memory in the NVSSM subsystem, while associated file system metadata are stored in non-volatile DRAM in the NVSSM subsystem. This approach allows updates to file system metadata to be made without having to incur the cost of erasing flash blocks, which is beneficial since file system metadata tends to be frequently updated. Further, when a sequence of RDMA operations is sent by the processing system to the NVSSM subsystem, completion status may be suppressed for all of the individual RDMA operations except the last one.

The techniques introduced here have a number of possible advantages. One is that the use of an RDMA semantic to provide virtual machine fault isolation improves performance and reduces the complexity of the hypervisor for fault isolation support. It also provides support for virtual machines' bypassing the hypervisor completely and performing I/O operations themselves once the hypervisor sets up virtual machine access to the NVSSM subsystem, thus further improving performance and reducing overhead on the core for “domain 0”, which runs the hypervisor.

Another possible advantage is the performance improvement achieved by combining multiple I/O operations into single RDMA operation. This includes support for data resiliency by supporting multiple data redundancy techniques using RDMA primitives. Yet another possible advantage is improved support for virtual machine data sharing through the use of RDMA atomic operations. Still another possible advantage is the extension of flash memory (or other NVSSM memory) to support filesystem metadata for a single virtual machine and for shared virtual machine data. Another possible advantage is support for multiple flash devices behind a node supporting virtual machines, by extending the RDMA semantic. Further, the techniques introduced above allow shared and independent NVSSM caches and permanent storage in NVSSM devices under virtual machines.

As noted above, in certain embodiments the NVSSM subsystem includes “raw” flash memory, and the storage of data in the NVSSM subsystem is controlled by an external (relative to the flash device), log structured data layout engine of a processing system which employs a write anywhere storage policy. By “raw”, what is meant is a memory device that does not have any on-board data layout engine (in contrast with conventional flash SSDs). A “data layout engine” is defined herein as any element (implemented in software and/or hardware) that decides where to store data and locates data that is already stored. “Log structured”, as the term is defined herein, means that the data layout engine lays out its write patterns in a generally sequential fashion (similar to a log) and performs all writes to free blocks.

The NVSSM subsystem can be used as the primary persistent storage of a processing system, or as the main memory of a processing system, or both (or as a portion thereof). Further, the NVSSM subsystem can be made accessible to multiple processing systems, one or more of which implement virtual machine environments.

In some embodiments, the data layout engine in the processing system implements a “write out-of-place” (also called “write anywhere”) policy when writing data to the flash memory (and elsewhere), as described further below. In this context, writing out-of-place means that whenever a logical data block is modified, that data block, as modified, is written to a new physical storage location, rather than overwriting it in place. (Note that a “logical data block” managed by the data layout engine in this context is not the same as a physical “block” of flash memory. A logical block is a virtualization of physical storage space, which does not necessarily correspond in size to a block of flash memory. In one embodiment, each logical data block managed by the data layout engine is 4 kB, whereas each physical block of flash memory is much larger, e.g., 128 kB.) Because the flash memory does not have any internal data layout engine, the external write-out-of-place data layout engine of the processing system can write data to any free location in flash memory. Consequently, the external write-out-of-place data layout engine can write modified data to a smaller number of erase blocks than if it had to rewrite the data in place, which helps to reduce wear on flash devices.

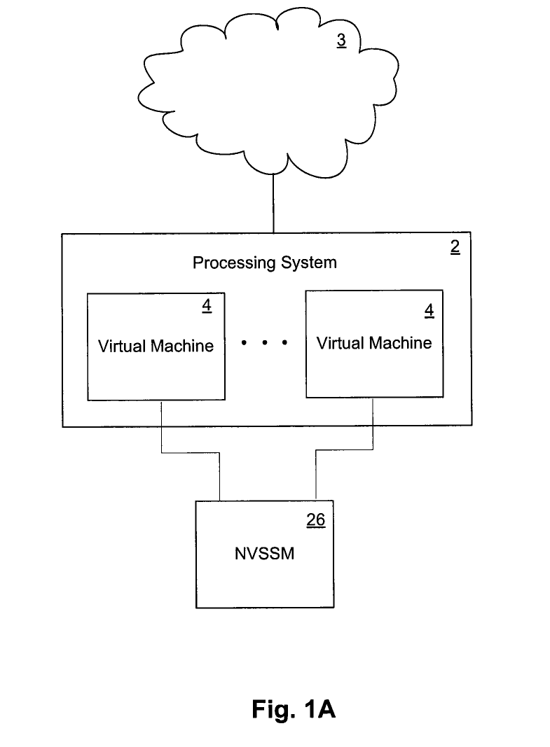

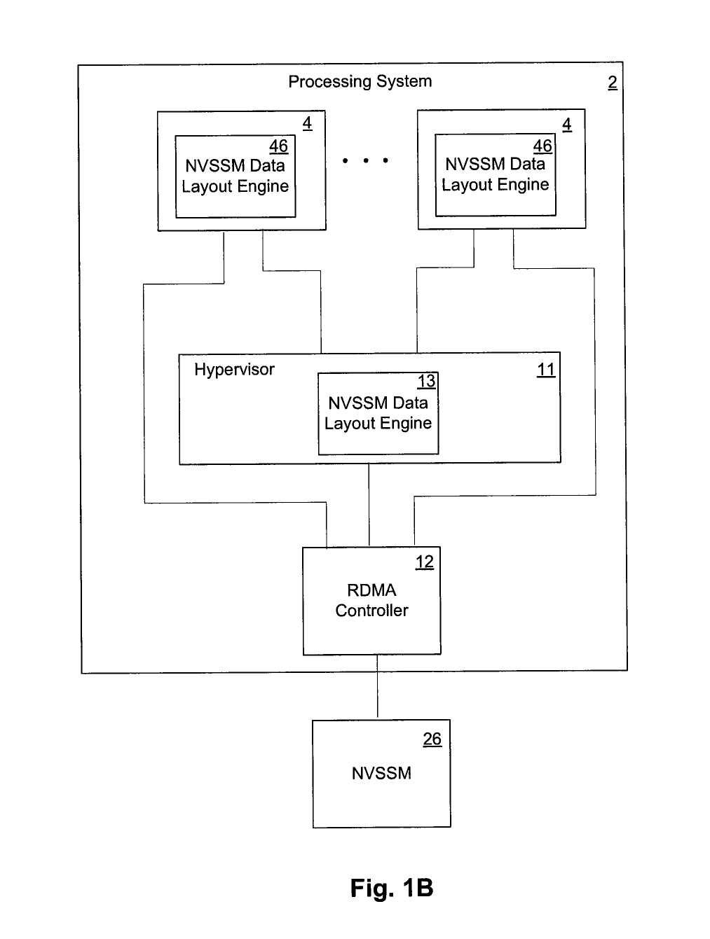

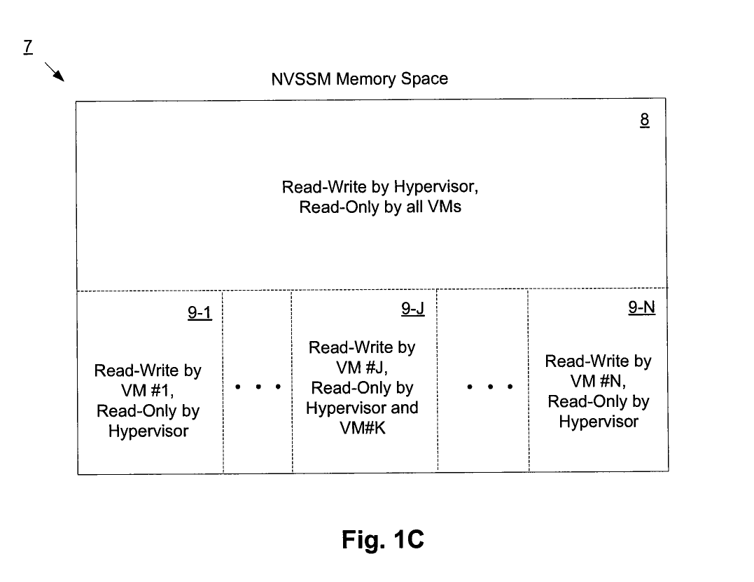

Refer now to FIG. 1A, which shows a processing system in which the techniques introduced here can be implemented. In FIG. 1A, a processing system 2 includes multiple virtual machines 4, all sharing the same hardware, which includes NVSSM subsystem 26. Each virtual machine 4 may be, or may include, a complete operating system. Although only two virtual machines 4 are shown, it is to be understood that essentially any number of virtual machines could reside and execute in the processing system 2. The processing system 2 can be coupled to a network 3, as shown, which can be, for example, a local area network (LAN), wide area network (WAN), metropolitan area network (MAN), global area network such as the Internet, a Fibre Channel fabric, or any combination of such interconnects.

The NVSSM subsystem 26 can be within the same physical platform/housing as that which contains the virtual machines 4, although that is not necessarily the case. In some embodiments, the virtual machines 4 and the NVSSM subsystem 26 may all be considered to be part of a single processing system; however, that does not mean the NVSSM subsystem 26 must be in the same physical platform as the virtual machines 4.

In one embodiment, the processing system 2 is a network storage server. The storage server may provide file-level data access services to clients (not shown), such as commonly done in a NAS environment, or block-level data access services such as commonly done in a SAN environment, or it may be capable of providing both file-level and block-level data access services to clients.

Further, although the processing system 2 is illustrated as a single unit in FIG. 1, it can have a distributed architecture. For example, assuming it is a storage server, it can be designed to include one or more network modules (e.g., “N-blade”) and one or more disk/data modules (e.g., “D-blade”) (not shown) that are physically separate from the network modules, where the network modules and disk/data modules communicate with each other over a physical interconnect. Such an architecture allows convenient scaling of the processing system.

FIG. 1B illustrates the system of FIG. 1A in greater detail. As shown, the system further includes a hypervisor 11 and an RDMA controller 12. The RDMA controller 12 controls RDMA operations which enable the virtual machines 4 to access NVSSM subsystem 26 for purposes of reading and writing data, as described further below. The hypervisor 11 communicates with each virtual machine 4 and the RDMA controller 12 to provide virtualization services that are commonly associated with a hypervisor in a virtual machine environment. In addition, the hypervisor 11 also generates tags such as RDMA Steering Tags (STags) to assign each virtual machine 4 a particular portion of the NVSSM subsystem 26. This means providing each virtual machine 4 with exclusive write access to a separate portion of the NVSSM subsystem 26.

By assigning a “particular portion”, what is meant is assigning a particular portion of the memory space of the NVSSM subsystem 26, which does not necessarily mean assigning a particular physical portion of the NVSSM subsystem 26. Nonetheless, in some embodiments, assigning different portions of the memory space of the NVSSM subsystem 26 may in fact involve assigning distinct physical portions of the NVSSM subsystem 26.

The use of an RDMA semantic in this way to provide virtual machine fault isolation improves performance and reduces the overall complexity of the hypervisor 11 for fault isolation support.

In operation, once each virtual machine 4 has received its STag(s) from the hypervisor 11, it can access the NVSSM subsystem 26 by communicating through the RDMA controller 12, without involving the hypervisor 11. This technique, therefore, also improves performance and reduces overhead on the processor core for “domain 0”, which runs the hypervisor 11.

The hypervisor 11 includes an NVSSM data layout engine 13 which can control RDMA operations and is responsible for determining the placement of data and flash wear-leveling within the NVSSM subsystem 26, as described further below. This functionality includes generating scatter-gather lists for RDMA operations performed on the NVSSM subsystem 26. In certain embodiments, at least some of the virtual machines 4 also include their own NVSSM data layout engines 46, as illustrated in FIG. 1B, which can perform similar functions to those performed by the hypervisor's NVSSM data layout engine 13. A NVSSM data layout engine 46 in a virtual machine 4 covers only the portion of memory in the NVSSM subsystem 26 that is assigned to that virtual machine. The functionality of these data layout engines is described further below.

In one embodiment, as illustrated in FIG. 1C, the hypervisor 11 has both read and write access to a portion 8 of the memory space 7 of the NVSSM subsystem 26, whereas each of the virtual machines 4 has only read access to that portion 8. Further, each virtual machine 4 has both read and write access to its own separate portion 9-1 . . . 9-N of the memory space 7 of the NVSSM subsystem 26, whereas the hypervisor 11 has only read access to those portions 9-1 . . . 9-N. Optionally, one or more of the virtual machines 4 may also be provided with read-only access to the portion belonging to one or more other virtual machines, as illustrated by the example of memory portion 9-J. In other embodiments, a different manner of allocating virtual machines' access privileges to the NVSSM subsystem 26 can be employed.

In addition, in certain embodiments, data consistency is maintained by providing remote locks at the NVSSM 26. More particularly, these are achieved by causing each virtual machine 4 to access the NVSSM subsystem 26 remote locks memory through the RDMA controller only by using atomic memory access operations. This alleviates the need for a distributed lock manager and simplifies fault handling, since lock and data are on the same memory. Any number of atomic operations can be used. Two specific examples which can be used to support all other atomic operations are: compare and swap; and, fetch and add.

From the above description, it can be seen that the hypervisor 11 generates STags to control fault isolation of the virtual machines 4. In addition, the hypervisor 11 can also generate STags to implement a wear-leveling scheme across the NVSSM subsystem 26 and/or to implement load balancing across the NVSSM subsystem 26, and/or for other purposes.

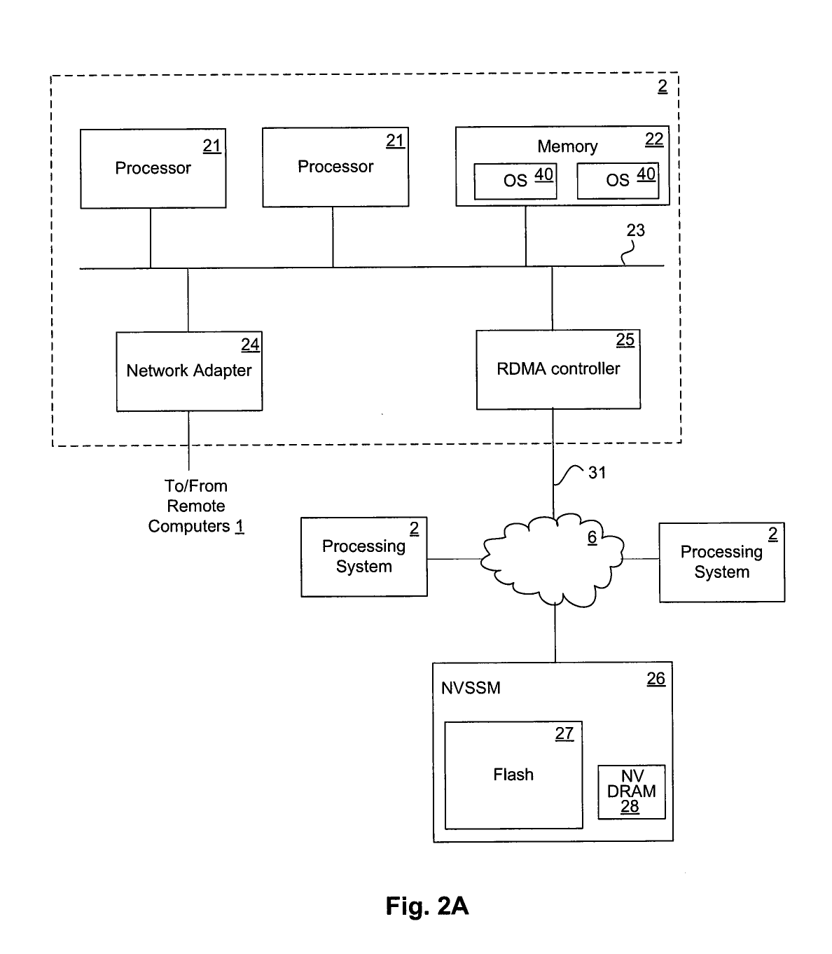

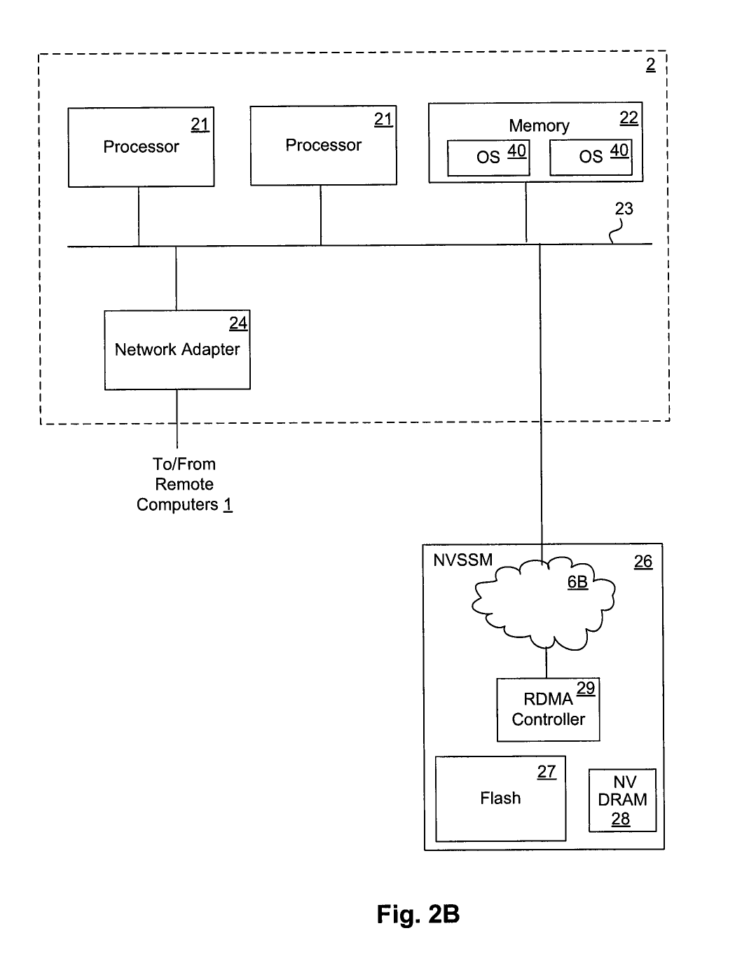

FIG. 2A is a high-level block diagram showing an example of the architecture of the processing system 2 and the NVSSM subsystem 26, according to one embodiment. The processing system 2 includes multiple processors 21 and memory 22 coupled to a interconnect 23. The interconnect 23 shown in FIG. 2A is an abstraction that represents any one or more separate physical buses, point-to-point connections, or both connected by appropriate bridges, adapters, or controllers. The interconnect 23, therefore, may include, for example, a system bus, a Peripheral Component Interconnect (PCI) family bus, a HyperTransport or industry standard architecture (ISA) bus, a small computer system interface (SCSI) bus, a universal serial bus (USB), IIC (I2C) bus, an Institute of Electrical and Electronics Engineers (IEEE) standard 1394 bus (sometimes referred to as “Firewire”), or any combination of such interconnects.

The processors 21 include central processing units (CPUs) of the processing system 2 and, thus, control the overall operation of the processing system 2. In certain embodiments, the processors 21 accomplish this by executing software or firmware stored in memory 22. The processors 21 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 22 is, or includes, the main memory of the processing system 2. The memory 22 represents any form of random access memory (RAM), read-only memory (ROM), flash memory, or the like, or a combination of such devices. In use, the memory 22 may contain, among other things, multiple operating systems 40, each of which is (or is part of) a virtual machine 4. The multiple operating systems 40 can be different types of operating systems or different instantiations of one type of operating system, or a combination of these alternatives.

Also connected to the processors 21 through the interconnect 23 are a network adapter 24 and an RDMA controller 25. Storage adapter 25 is henceforth referred to as the “host RDMA controller” 25. The network adapter 24 provides the processing system 2 with the ability to communicate with remote devices over the network 3 and may be, for example, an Ethernet, Fibre Channel, ATM, or Infiniband adapter.

The RDMA techniques described herein can be used to transfer data between host memory in the processing system 2 (e.g., memory 22) and the NVSSM subsystem 26. Host RDMA controller 25 includes a memory map of all of the memory in the NVSSM subsystem 26. The memory in the NVSSM subsystem 26 can include flash memory 27 as well as some form of non-volatile DRAM 28 (e.g., battery backed DRAM). Non-volatile DRAM 28 is used for storing filesystem metadata associated with data stored in the flash memory 27, to avoid the need to erase flash blocks due to updates of such frequently updated metadata. Filesystem metadata can include, for example, a tree structure of objects, such as files and directories, where the metadata of each of these objects recursively has the metadata of the filesystem as if it were rooted at that object. In addition, filesystem metadata can include the names, sizes, ownership, access privileges, etc. for those objects.

As can be seen from FIG. 2A, multiple processing systems 2 can access the NVSSM subsystem 26 through the external interconnect 6. FIG. 2B shows an alternative embodiment, in which the NVSSM subsystem 26 includes an internal fabric 6B, which is directly coupled to the interconnect 23 in the processing system 2. In one embodiment, fabric 6B and interconnect 23 both implement PCIe protocols. In an embodiment according to FIG. 2B, the NVSSM subsystem 26 further includes an RDMA controller 29, hereinafter called the “storage RDMA controller” 29. Operation of the storage RDMA controller 29 is discussed further below.

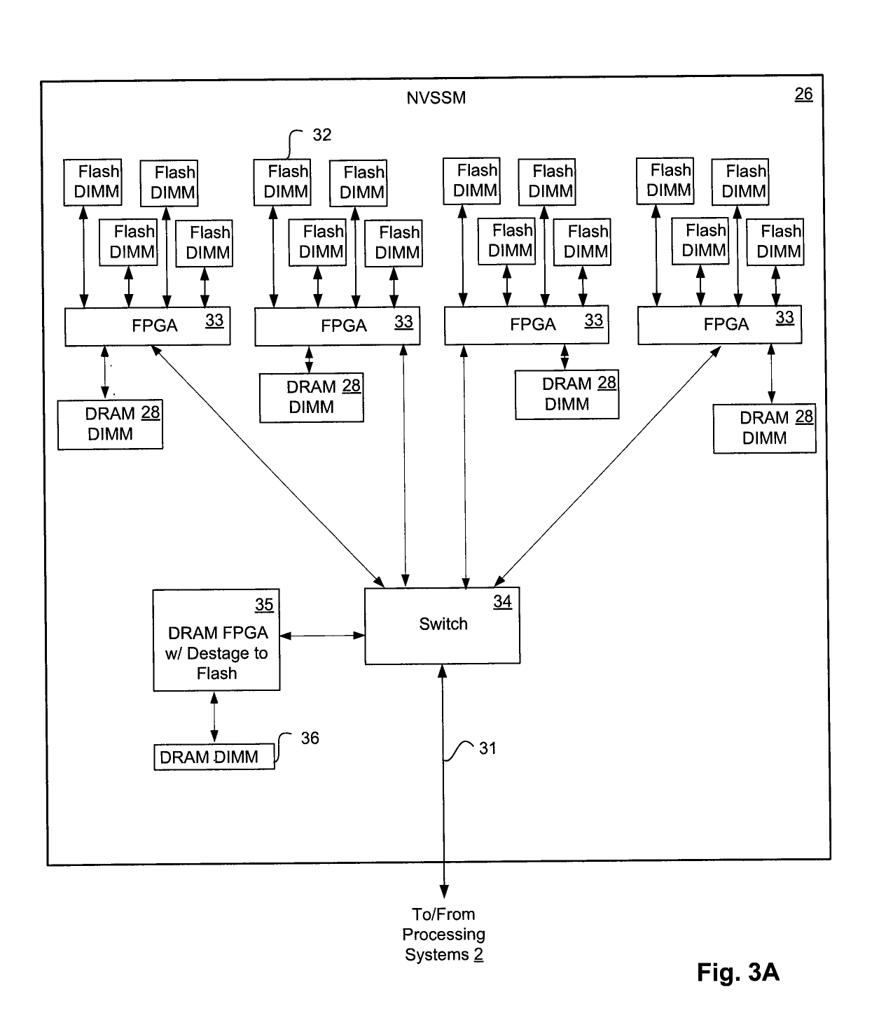

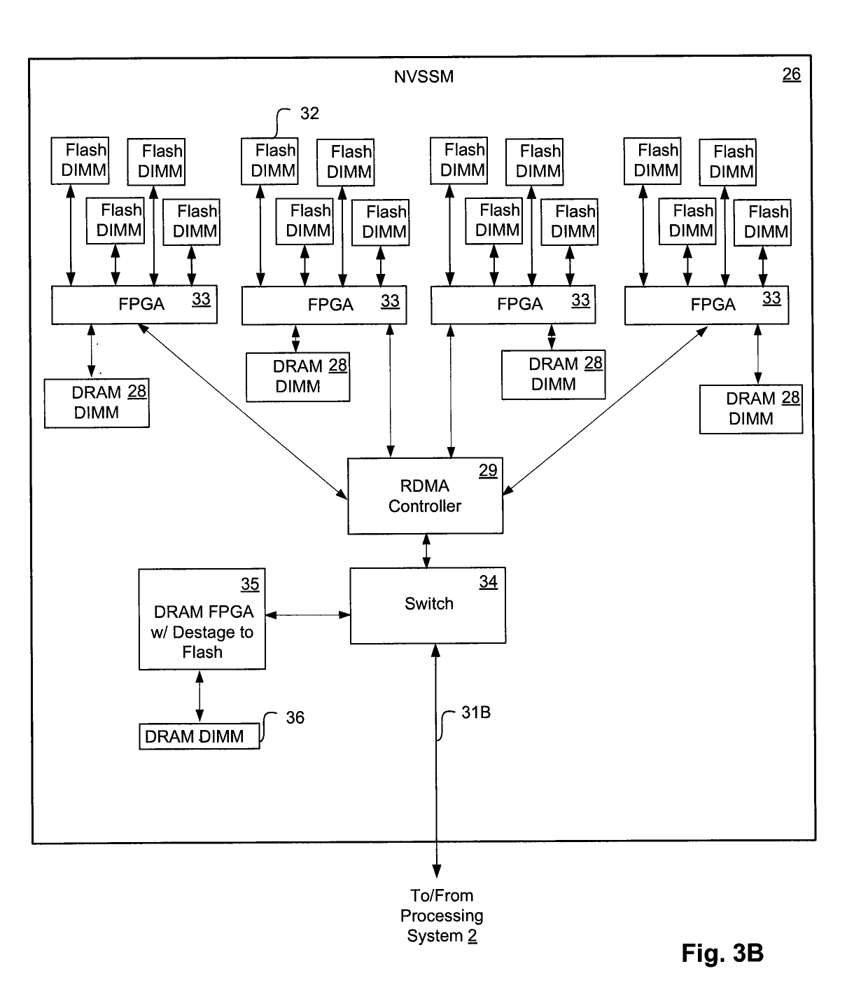

FIG. 3A shows an example of the NVSSM subsystem 26 according to an embodiment of the invention corresponding to FIG. 2A. In the illustrated embodiment, the NVSSM subsystem 26 includes: a host interconnect 31, a number of NAND flash memory modules 32, and a number of flash controllers 33, shown as field programmable gate arrays (FPGAs). To facilitate description, the memory modules 32 are henceforth assumed to be DIMMs, although in another embodiment they could be a different type of memory module. In one embodiment, these components of the NVSSM subsystem 26 are implemented on a conventional substrate, such as a printed circuit board or add-in card.

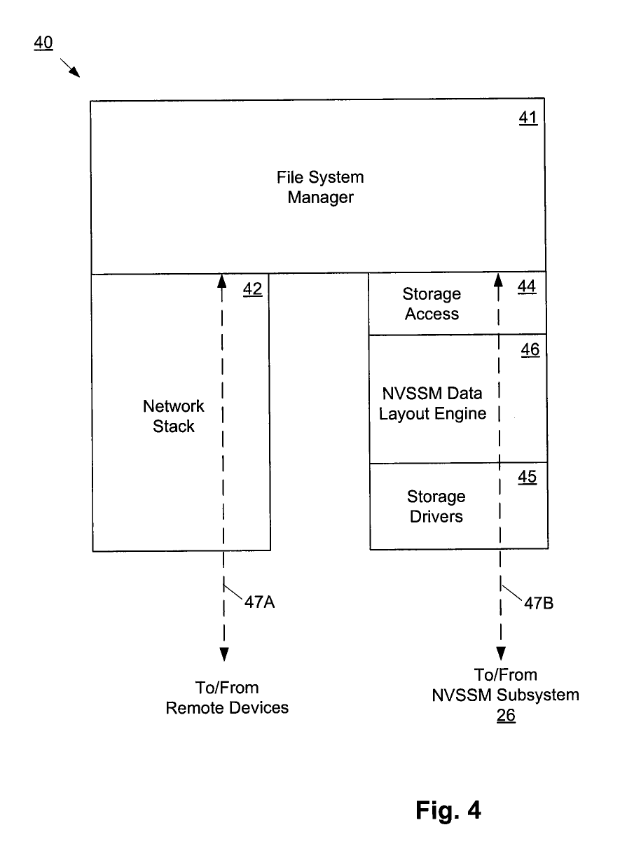

In the basic operation of the NVSSM subsystem 26, data is scheduled into the NAND flash devices by one or more data layout engines located external to the NVSSM subsystem 26, which may be part of the operating systems 40 or the hypervisor 11 running on the processing system 2. An example of such a data layout engine is described in connection with FIGS. 1B and 4. To maintain data integrity, in addition to the typical error correction codes used in each NAND flash component, RAID data striping can be implemented (e.g., RAID-3, RAID-4, RAID-5, RAID-6, RAID-DP) across each flash controller 33.

In the illustrated embodiment, the NVSSM subsystem 26 also includes a switch 34, where each flash controller 33 is coupled to the interconnect 31 by the switch 34.

The NVSSM subsystem 26 further includes a separate battery backed DRAM DIMM coupled to each of the flash controllers 33, implementing the non-volatile DRAM 28. The non-volatile DRAM 28 can be used to store file system metadata associated with data being stored in the flash devices 32.

In the illustrated embodiment, the NVSSM subsystem 26 also includes another non-volatile (e.g., battery-backed) DRAM buffer DIMM 36 coupled to the switch 34. DRAM buffer DIMM 36 is used for short-term storage of data to be staged from, or destaged to, the flash devices 32. A separate DRAM controller 35 (e.g., FPGA) is used to control the DRAM buffer DIMM 36 and to couple the DRAM buffer DIMM 36 to the switch 34.

In contrast with conventional SSDs, the flash controllers 33 do not implement any data layout engine; they simply interface the specific signaling requirements of the flash DIMMs 32 with those of the host interconnect 31. As such, the flash controllers 33 do not implement any data indirection or data address virtualization for purposes of accessing data in the flash memory. All of the usual functions of a data layout engine (e.g., determining where data should be stored and locating stored data) are performed by an external data layout engine in the processing system 2. Due to the absence of a data layout engine within the NVSSM subsystem 26, the flash DIMMs 32 are referred to as “raw” flash memory.

Note that the external data layout engine may use knowledge of the specifics of data placement and wear leveling within flash memory. This knowledge and functionality could be implemented within a flash abstraction layer, which is external to the NVSSM subsystem 26 and which may or may not be a component of the external data layout engine.

FIG. 3B shows an example of the NVSSM subsystem 26 according to an embodiment of the invention corresponding to FIG. 2B. In the illustrated embodiment, the internal fabric 6B is implemented in the form of switch 34, which can be a PCI express (PCIe) switch, for example, in which case the host interconnect 31B is a PCIe bus. The switch 34 is coupled directly to the internal interconnect 23 of the processing system 2. In this embodiment, the NVSSM subsystem 26 also includes RDMA controller 29, which is coupled between the switch 34 and each of the flash controllers 33. Operation of the RDMA controller 29 is discussed further below.

FIG. 4 schematically illustrates an example of an operating system that can be implemented in the processing system 2, which may be part of a virtual machine 4 or may include one or more virtual machines 4. As shown, the operating system 40 is a network storage operating system which includes several software modules, or “layers”. These layers include a file system manager 41, which is the core functional element of the operating system 40. The file system manager 41 is, in certain embodiments, software, which imposes a structure (e.g., a hierarchy) on the data stored in the PPS subsystem 4 (e.g., in the NVSSM subsystem 26), and which services read and write requests from clients 1. In one embodiment, the file system manager 41 manages a log structured file system and implements a “write out-of-place” (also called “write anywhere”) policy when writing data to long-term storage. In other words, whenever a logical data block is modified, that logical data block, as modified, is written to a new physical storage location (physical block), rather than overwriting the data block in place. As mentioned above, this characteristic removes the need (associated with conventional flash memory) to erase and rewrite the entire block of flash anytime a portion of that block is modified. Note that some of these functions of the file system manager 41 can be delegated to a NVSSM data layout engine 13 or 46, as described below, for purposes of accessing the NVSSM subsystem 26.

Logically “under” the file system manager 41, to allow the processing system 2 to communicate over the network 3 (e.g., with clients), the operating system 40 also includes a network stack 42. The network stack 42 implements various network protocols to enable the processing system to communicate over the network 3.

Also logically under the file system manager 41, to allow the processing system 2 to communicate with the NVSSM subsystem 26, the operating system 40 includes a storage access layer 44, an associated storage driver layer 45, and may include an NVSSM data layout engine 46 disposed logically between the storage access layer 44 and the storage drivers 45. The storage access layer 44 implements a higher-level storage redundancy algorithm, such as RAID-3, RAID-4, RAID-5, RAID-6 or RAID-DP. The storage driver layer 45 implements a lower-level protocol.

The NVSSM data layout engine 46 can control RDMA operations and is responsible for determining the placement of data and flash wear-leveling within the NVSSM subsystem 26, as described further below. This functionality includes generating scatter-gather lists for RDMA operations performed on the NVSSM subsystem 26.

It is assumed that the hypervisor 11 includes its own data layout engine 13 with functionality such as described above. However, a virtual machine 4 may or may not include its own data layout engine 46. In one embodiment, the functionality of any one or more of these NVSSM data layout engines 13 and 46 is implemented within the RDMA controller.

If a particular virtual machine 4 does include its own data layout engine 46, then it uses that data layout engine to perform I/O operations on the NVSSM subsystem 26. Otherwise, the virtual machine uses the data layout engine 13 of the hypervisor 11 to perform such operations. To facilitate explanation, the remainder of this description assumes that virtual machines 4 do not include their own data layout engines 46. Note, however, that essentially all of the functionality described herein as being implemented by the data layout engine 13 of the hypervisor 11 can also be implemented by a data layout engine 46 in any of the virtual machines 4.

The storage driver layer 45 controls the host RDMA controller 25 and implements a network protocol that supports conventional RDMA, such as FCVI, InfiniBand, or iWarp. Also shown in FIG. 4 are the main paths 47A and 47B of data flow, through the operating system 40.

Both read access and write access to the NVSSM subsystem 26 are controlled by the operating system 40 of a virtual machine 4. The techniques introduced here use conventional RDMA techniques to allow efficient transfer of data to and from the NVSSM subsystem 26, for example, between the memory 22 and the NVSSM subsystem 26. It can be assumed that the RDMA operations described herein are generally consistent with conventional RDMA standards, such as InfiniBand (InfiniBand Trade Association (IBTA)) or IETF iWarp (see, e.g.: RFC 5040, A Remote Direct Memory Access Protocol Specification, October 2007; RFC 5041, Direct Data Placement over Reliable Transports; RFC 5042, Direct Data Placement Protocol (DDP)/Remote Direct Memory Access Protocol (RDMAP) Security IETF proposed standard; RFC 5043, Stream Control Transmission Protocol (SCTP) Direct Data Placement (DDP) Adaptation; RFC 5044, Marker PDU Aligned Framing for TCP Specification; RFC 5045, Applicability of Remote Direct Memory Access Protocol (RDMA) and Direct Data Placement Protocol (DDP); RFC 4296, The Architecture of Direct Data Placement (DDP) and Remote Direct Memory Access (RDMA) on Internet Protocols; RFC 4297, Remote Direct Memory Access (RDMA) over IP Problem Statement).

In an embodiment according to FIGS. 2A and 3A, prior to normal operation (e.g., during initialization of the processing system 2), the hypervisor 11 registers with the host RDMA controller 25 at least a portion of the memory space in the NVSSM subsystem 26, for example memory 22. This involves the hypervisor 41 using one of the standard memory registration calls specifying the portion or the whole memory 22 to the host RDMA controller 25, which in turn returns an STag to be used in the future when calling the host RDMA controller 25.

In one embodiment consistent with FIGS. 2A and 3A, the NVSSM subsystem 26 also provides to host RDMA controller 25 RDMA STags for each NVSSM memory subset 9-1 through 9-N (FIG. 1C) granular enough to support a virtual machine, which provides them to the NVSSM data layout engine 13 of the hypervisor 11. When the virtual machine is initialized the hypervisor 11 provides the virtual machine with an STag corresponding to that virtual machine. That STag provides exclusive write access to corresponding subset of NVSSM memory. In one embodiment the hypervisor may provide the initializing virtual machine an STag of another virtual machine for read-only access to a subset of the other virtual machine's memory. This can be done to support shared memory between virtual machines.

For each granular subset of the NVSSM memory 26, the NVSSM subsystem 26 also provides to host RDMA controller 25 an RDMA STag and a location of a lock used for accesses to that granular memory subset, which then provides the STag to the NVSSM data layout engine 13 of the hypervisor 11.

If multiple processing systems 2 are sharing the NVSSM subsystem 26, then each processing system 2 may have access to a different subset of memory in the NVSSM subsystem 26. In that case, the STag provided in each processing system 2 identifies the appropriate subset of NVSSM memory to be used by that processing system 2. In one embodiment, a protocol which is external to the NVSSM subsystem 26 is used between processing systems 2 to define which subset of memory is owned by which processing system 2. The details of such protocol are not germane to the techniques introduced here; any of various conventional network communication protocols could be used for that purpose. In another embodiment, some or all of memory of DIMM 28 is mapped to an RDMA STag for each processing system 2 and shared data stored in that memory is used to determine which subset of memory is owned by which processing system 2. Furthermore, in another embodiment, some or all of the NVSSM memory can be mapped to an STag of different processing systems 2 to be shared between them for read and write data accesses. Note that the algorithms for synchronization of memory accesses between processing systems 2 are not germane to the techniques being introduced here.

In the embodiment of FIGS. 2A and 3A, prior to normal operation (e.g., during initialization of the processing system 2), the hypervisor 11 registers with the host RDMA controller 25 at least a portion of processing system 2 memory space, for example memory 22. This involves the hypervisor 11 using one of the standard memory registration calls specifying the portion or the whole memory 22 to the host RDMA controller 25 when calling the host RDMA controller 25.

In one embodiment consistent with FIGS. 2B and 3B, the NVSSM subsystem 26 also provides to host RDMA controller 29 RDMA STags for each NVSSM memory subset 9-1 through 9-N (FIG. 1C) granular enough to support a virtual machine, which provides them to the NVSSM data layout engine 13 of the hypervisor 11. When the virtual machine is initialized the hypervisor 11 provides the virtual machine with an STag corresponding to that virtual machine. That STag provides exclusive write access to corresponding subset of NVSSM memory. In one embodiment the hypervisor may provide the initializing virtual machine an STag of another virtual machine for read-only access to a subset of the other virtual machine's memory. This can be done to support shared memory between virtual machines.

In the embodiment of FIGS. 2B and 3B, prior to normal operation (e.g., during initialization of the processing system 2), the hypervisor 11 registers with the host RDMA controller 29 at least a portion of processing system 2 memory space, for example memory 22. This involves the hypervisor 11 using one of the standard memory registration calls specifying the portion or the whole memory 22 to the host RDMA controller 29 when calling the host RDMA controller 29.

During normal operation, the NVSSM data layout engine 13 (FIG. 1B) generates scatter-gather lists to specify the RDMA read and write operations for transferring data to and from the NVSSM subsystem 26. A “scatter-gather list” is a pairing of a scatter list and a gather list. A scatter list or gather list is a list of entries (also called “vectors” or “pointers”), each of which includes the STag for the NVSSM subsystem 26 as well as the location and length of one segment in the overall read or write request. A gather list specifies one or more source memory segments from where data is to be retrieved at the source of an RDMA transfer, and a scatter list specifies one or more destination memory segments to where data is to be written at the destination of an RDMA transfer. Each entry in a scatter list or gather list includes the STag generated during initialization. However, in accordance with the technique introduced here, a single RDMA STag can be generated to specify multiple segments in different subsets of non-volatile solid-state memory in the NVSSM subsystem 26, at least some of which may have different access permissions (e.g., some may be read/write or as some may be read only). Further, a single STag that represents processing system memory can specify multiple segments in different subsets of a processing system's buffer cache 6, at least some of which may have different access permissions. Multiple segments in different subsets of a processing system buffer cache 6 may have different access permissions.

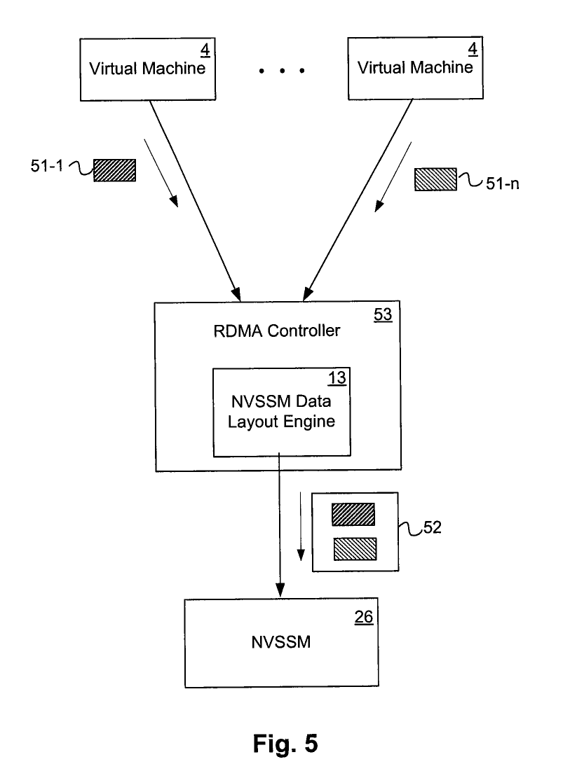

As noted above, the hypervisor 11 includes an NVSSM data layout engine 13, which can be implemented in an RDMA controller 53 of the processing system 2, as shown in FIG. 5. RDMA controller 53 can represent, for example, the host RDMA controller 25 in FIG. 2A. The NVSSM data layout engine 13 can combine multiple client-initiated data access requests 51-1 . . . 51-n (read requests or write requests) into a single RDMA data access 52 (RDMA read or write). The multiple requests 51-1 . . . 51-n may originate from two or more different virtual machines 4. Similarly, an NVSSM data layout engine 46 within a virtual machine 4 can combine multiple data access requests from its host file system manager 41 (FIG. 4) or some other source into a single RDMA access.

The single RDMA data access 52 includes a scatter-gather list generated by NVSSM data layout engine 13, where data layout engine 13 generates a list for NVSSM subsystem 26 and the file system manager 41 of a virtual machine generates a list for processing system internal memory (e.g., buffer cache 6). A scatter list or a gather list can specify multiple memory segments at the source or destination (whichever is applicable). Furthermore, a scatter list or a gather list can specify memory segments that are in different subsets of memory.

In the embodiment of FIGS. 2B and 3B, the single RDMA read or write is sent to the NVSSM subsystem 26 (as shown in FIG. 5), where it decomposed by the storage RDMA controller 29 into multiple data access operations (reads or writes), which are then executed in parallel or sequentially by the storage RDMA controller 29 in the NVSSM subsystem 26. In the embodiment of FIGS. 2A and 3A, the single RDMA read or write is decomposed into multiple data access operations (reads or writes) within the processing system 2 by the host RDMA 25 controller, and these multiple operations are then executed in parallel or sequentially on the NVSSM subsystem 26 by the host RDMA 25 controller.

The processing system 2 can initiate a sequence of related RDMA reads or writes to the NVSSM subsystem 26 (where any individual RDMA read or write in the sequence can be a compound RDMA operation as described above). Thus, the processing system 2 can convert any combination of one or more client-initiated reads or writes or any other data or metadata operations into any combination of one or more RDMA reads or writes, respectively, where any of those RDMA reads or writes can be a compound read or write, respectively.

In cases where the processing system 2 initiates a sequence of related RDMA reads or writes or any other data or metadata operation to the NVSSM subsystem 26, it may be desirable to suppress completion status for all of the individual RDMA operations in the sequence except the last one. In other words, if a particular RDMA read or write is successful, then “completion” status is not generated by the NVSSM subsystem 26, unless it is the last operation in the sequence. Such suppression can be done by using conventional RDMA techniques. “Completion” status received at the processing system 2 means that the written data is in the NVSSM subsystem memory, or read data from the NVSSM subsystem is in processing system memory, for example in buffer cache 6, and valid. In contrast, “completion failure” status indicates that there was a problem executing the operation in the NVSSM subsystem 26, and, in the case of an RDMA write, that the state of the data in the NVSSM locations for the RDMA write operation is undefined, while the state of the data at the processing system from which it is written to NVSSM is still intact. Failure status for a read means that the data is still intact in the NVSSM but the status of processing system memory is undefined. Failure also results in invalidation of the STag that was used by the RDMA operation; however, the connection between a processing system 2 and NVSSM 26 remains intact and can be used, for example, to generate new STag.

In certain embodiments, MSI-X (message signaled interrupts (MSI) extension) is used to indicate an RDMA operation's completion and to direct interrupt handling to a specific processor core, for example, for a core where the hypervisor 11 is running or a core where specific virtual machine is running. Moreover, the hypervisor 11 can direct MSI-X interrupt handling to a core which issued the I/O operation, thus improving the efficiency, reducing latency for users, and CPU burden on the hypervisor core.

Reads or writes executed in the NVSSM subsystem 26 can also be directed to different memory devices in the NVSSM subsystem 26. For example, in certain embodiments, user data and associated resiliency metadata (e.g., RAID parity data and checksums) are stored in raw flash memory within the NVSSM subsystem 26, while associated file system metadata is stored in non-volatile DRAM within the NVSSM subsystem 26. This approach allows updates to file system metadata to be made without incurring the cost of erasing flash blocks.

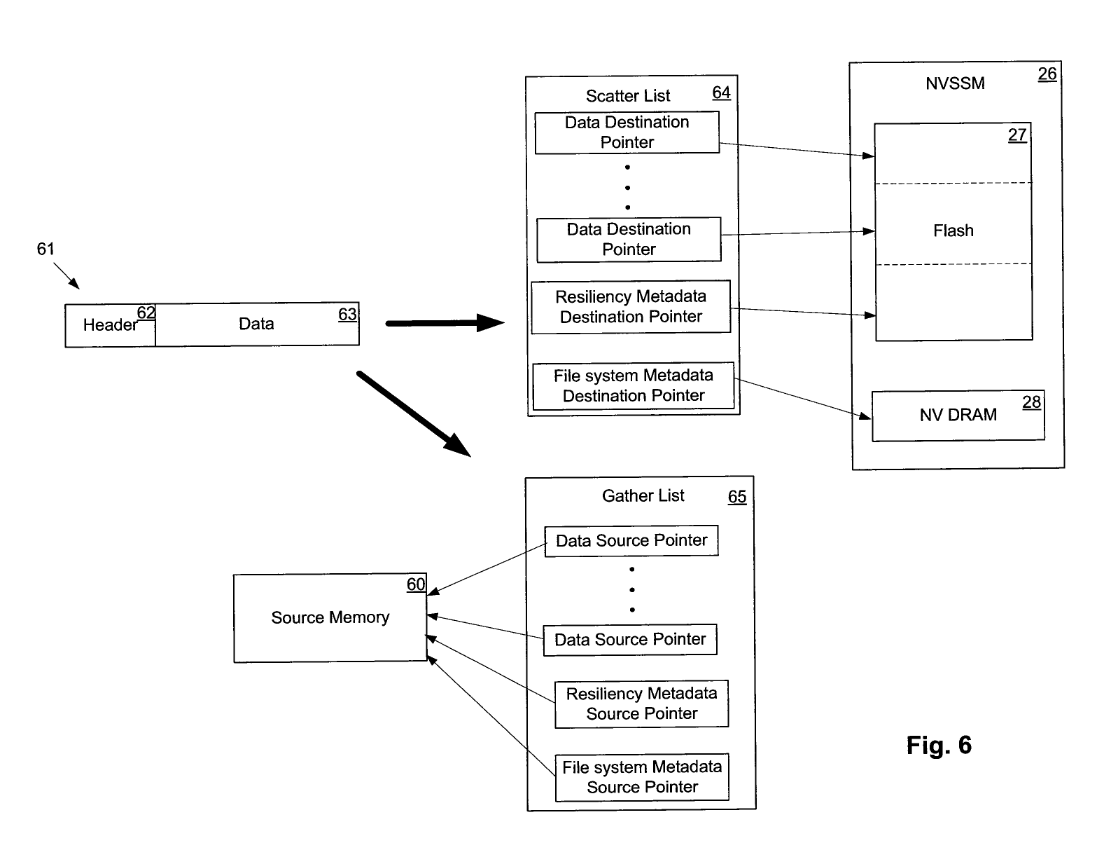

This approach is illustrated in FIGS. 6 through 9. FIG. 6 shows how a gather list and scatter list can be generated based on a single write 61 by a virtual machine 4. The write 61 includes one or more headers 62 and write data 63 (data to be written). The client-initiated write 61 can be in any conventional format.

The file system manager 41 in the processing system 2 initially stores the write data 63 in a source memory 60, which may be memory 22 (FIGS. 2A and 2B), for example, and then subsequently causes the write data 63 to be copied to the NVSSM subsystem 26.

Accordingly, the file system manager 41 causes the NVSSM data layout manager 46 to initiate an RDMA write, to write the data 63 from the processing system buffer cache 6 into the NVSSM subsystem 26. To initiate the RDMA write, the NVSSM data layout engine 13 generates a gather list 65 including source pointers to the buffers in source memory 60 where the write data 63 resides and where file system manager 41 generated corresponding RAID metadata and file metadata, and the NVSSM data layout engine 13 generates a corresponding scatter list 64 including destination pointers to where the data 63 and corresponding RAID metadata and file metadata shall be placed at NVSSM 26. In the case of an RDMA write, the gather list 65 specifies the memory locations in the source memory 60 from where to retrieve the data to be transferred, while the scatter list 64 specifies the memory locations in the NVSSM subsystem 26 into which the data is to be written. By specifying multiple destination memory locations, the scatter list 64 specifies multiple individual write accesses to be performed in the NVSSM subsystem 26.

The scatter-gather list 64, 65 can also include pointers for resiliency metadata generated by the virtual machine 4, such as RAID metadata, parity, checksums, etc. The gather list 65 includes source pointers that specify where such metadata is to be retrieved from in the source memory 60, and the scatter list 64 includes destination pointers that specify where such metadata is to be written to in the NVSSM subsystem 26. In the same way, the scatter-gather list 64, 65 can further include pointers for basic file system metadata 67, which specifies the NVSSM blocks where file data and resiliency metadata are written in NVSSM (so that the file data and resiliency metadata can be found by reading file system metadata). As shown in FIG. 6, the scatter list 64 can be generated so as to direct the write data and the resiliency metadata to be stored to flash memory 27 and the file system metadata to be stored to non-volatile DRAM 28 in the NVSSM subsystem 26. As noted above, this distribution of metadata storage allows certain metadata updates to be made without requiring erasure of flash blocks, which is particularly beneficial for frequently updated metadata. Note that some file system metadata may also be stored in flash memory 27, such as less frequently updated file system metadata. Further, the write data and the resiliency metadata may be stored to different flash devices or different subsets of the flash memory 27 in the NVSSM subsystem 26.

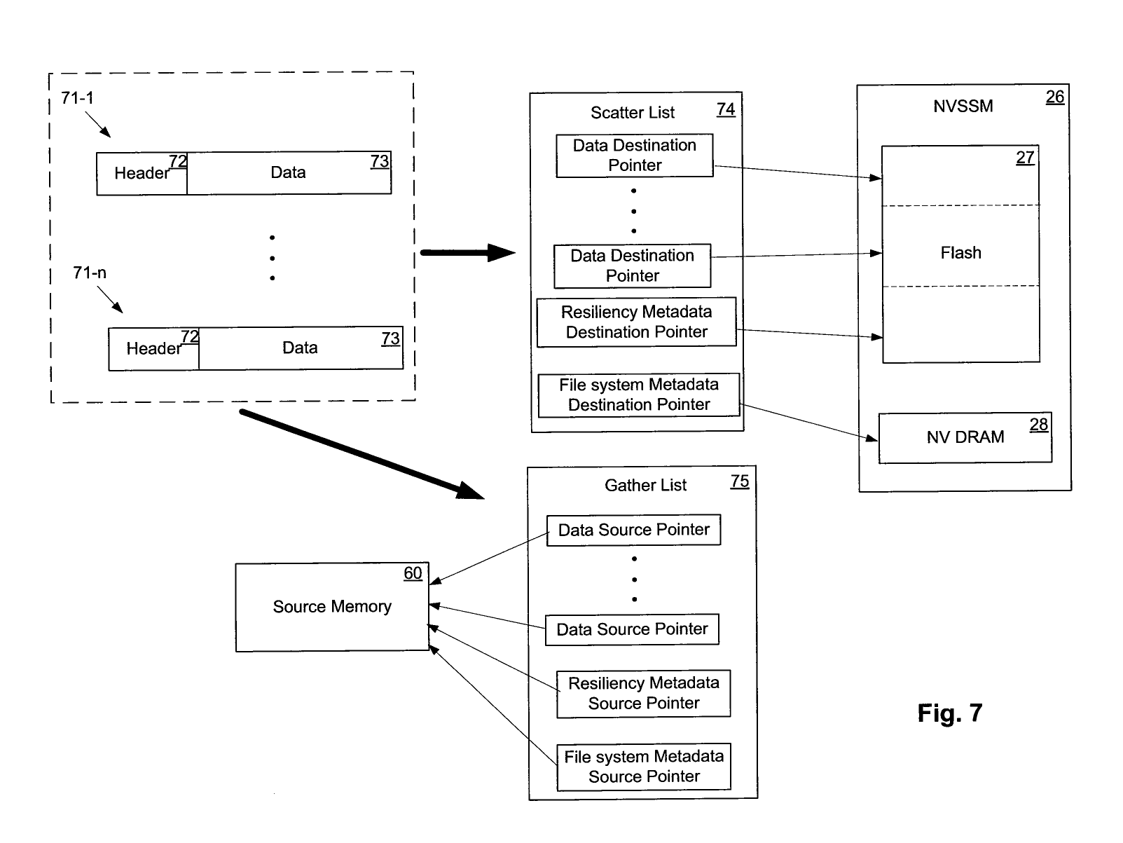

FIG. 7 illustrates how multiple client-initiated writes can be combined into a single RDMA write. In a manner similar to that discussed for FIG. 6, multiple client-initiated writes 71-1 . . . 71-n can be represented in a single gather list and a corresponding single scatter list 74, to form a single RDMA write. Write data 73 and metadata can be distributed in the same manner discussed above in connection with FIG. 6.

As is well known, flash memory is laid out in terms of erase blocks. Any time a write is performed to flash memory, the entire erase block or blocks that are targeted by the write must be first erased, before the data is written to flash. This erase-write cycle creates wear on the flash memory and, after a large number of such cycles, a flash block will fail. Therefore, to reduce the number of such erase-write cycles and thereby reduce the wear on the flash memory, the RDMA controller 12 can accumulate write requests and combine them into a single RDMA write, so that the single RDMA write substantially fills each erase block that it targets.

In certain embodiments, the RDMA controller 12 implements a RAID redundancy scheme to distribute data for each RDMA write across multiple memory devices within the NVSSM subsystem 26. The particular form of RAID and the manner in which data is distributed in this respect can be determined by the hypervisor 11, through the generation of appropriate STags. The RDMA controller 12 can present to the virtual machines 4 a single address space which spans multiple memory devices, thus allowing a single RDMA operation to access multiple devices but having a single completion. The RAID redundancy scheme is therefore transparent to each of the virtual machines 4. One of the memory devices in a flash bank can be used for storing checksums, parity and/or cyclic redundancy check (CRC) information, for example. This technique also can be easily extended by providing multiple NVSSM subsystems 26 such as described above, where data from a single write can be distributed across such multiple NVSSM subsystems 26in a similar manner.

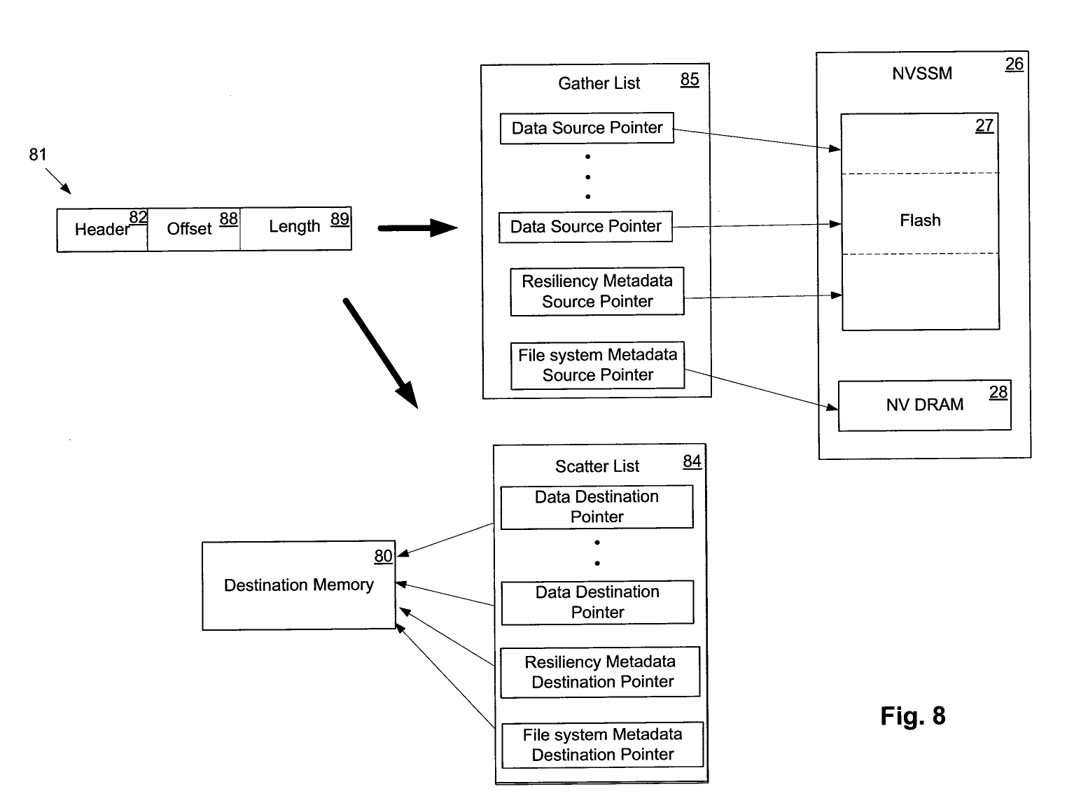

FIG. 8 shows how an RDMA read can be generated. Note that an RDMA read can reflect multiple read requests, as discussed below. A read request 81, in one embodiment, includes a header 82, a starting offset 88 and a length 89 of the requested data The client-initiated read request 81 can be in any conventional format.

If the requested data resides in the NVSSM subsystem 26, the NVSSM data layout manager 46 generates a gather list 85 for NVSSM subsystem 26 and the file system manager 41 generates a corresponding scatter list 84 for buffer cache 6, first to retrieve file metadata. In one embodiment, the file metadata is retrieved from the NVSSM's DRAM 28. In one RDMA read, file metadata can be retrieved for multiple file systems and for multiple files and directories in a file system. Based on the retrieved file metadata, a second RDMA read can then be issued, with file system manager 41 specifying a scatter list and NVSSM data layout manager 46 specifying a gather list for the requested read data. In the case of an RDMA read, the gather list 85 specifies the memory locations in the NVSSM subsystem 26 from which to retrieve the data to be transferred, while the scatter list 84 specifies the memory locations in a destination memory 80 into which the data is to be written. The destination memory 80 can be, for example, memory 22. By specifying multiple source memory locations, the gather list 85 can specify multiple individual read accesses to be performed in the NVSSM subsystem 26.

The gather list 85 also specifies memory locations from which file system metadata for the first RDMA read and resiliency (e.g., RAID metadata, checksums, etc.) and file system metadata for the second RDMA read are to be retrieved in the NVSSM subsystem 29. As indicated above, these various different types of data and metadata can be retrieved from different locations in the NVSSM subsystem 26, including different types of memory (e.g. flash 27 and non-volatile DRAM 28).

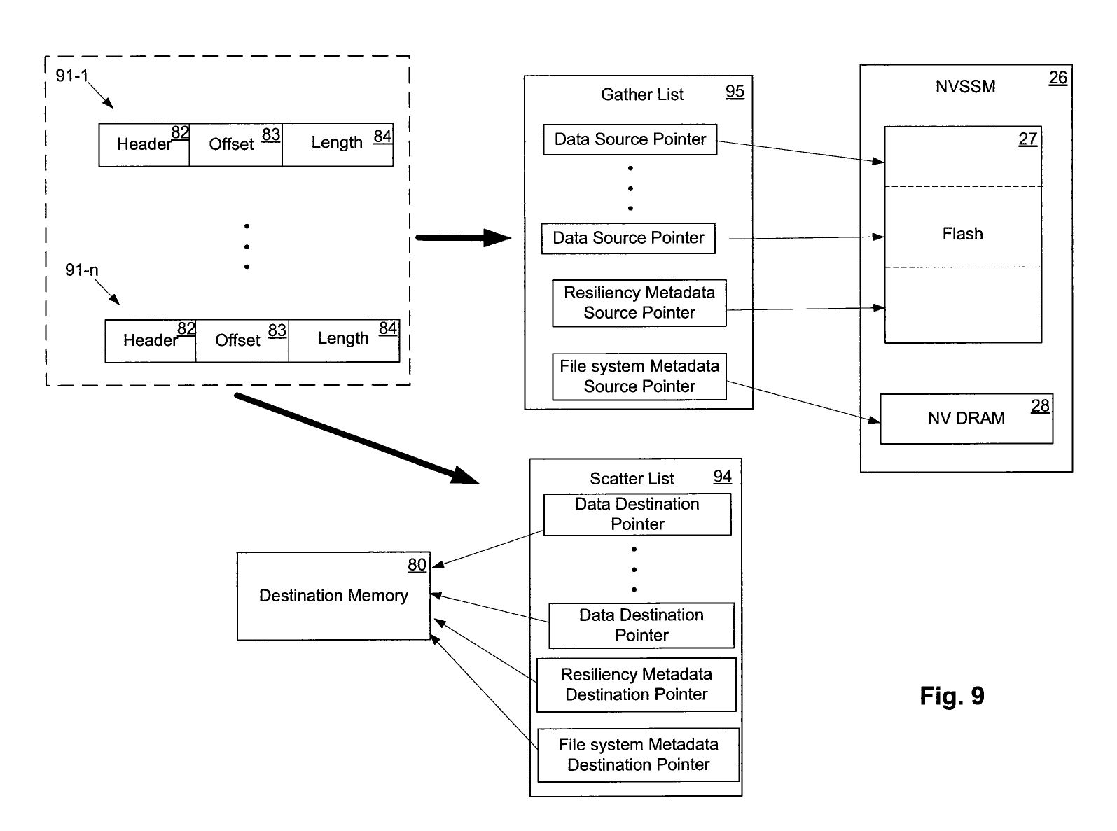

FIG. 9 illustrates how multiple client-initiated reads can be combined into a single RDMA read. In a manner similar to that discussed for FIG. 8, multiple client-initiated read requests 91-1 . . . 91-n can be represented in a single gather list 95 and a corresponding single scatter list 94 to form a single RDMA read for data and RAID metadata, and another single RDMA read for file system metadata. Metadata and read data can be gathered from different locations and/or memory devices in the NVSSM subsystem 26, as discussed above.

Note that one benefit of using the RDMA semantic is that even for data block updates there is a potential performance gain. For example, referring to FIG. 2B, data blocks that are to be updated can be read into the memory 22 of the processing system 2, updated by the file system manager 41 based on the RDMA write data, and then written back to the NVSSM subsystem 26. In one embodiment the data and metadata are written back to the NVSSM blocks from which they were taken. In another embodiment, the data and metadata are written into different blocks in the NVSSM subsystem and 26 and file metadata pointing to the old metadata locations is updated. Thus, only the modified data needs to cross the bus structure within the processing system 2, while much larger flash block data does not.

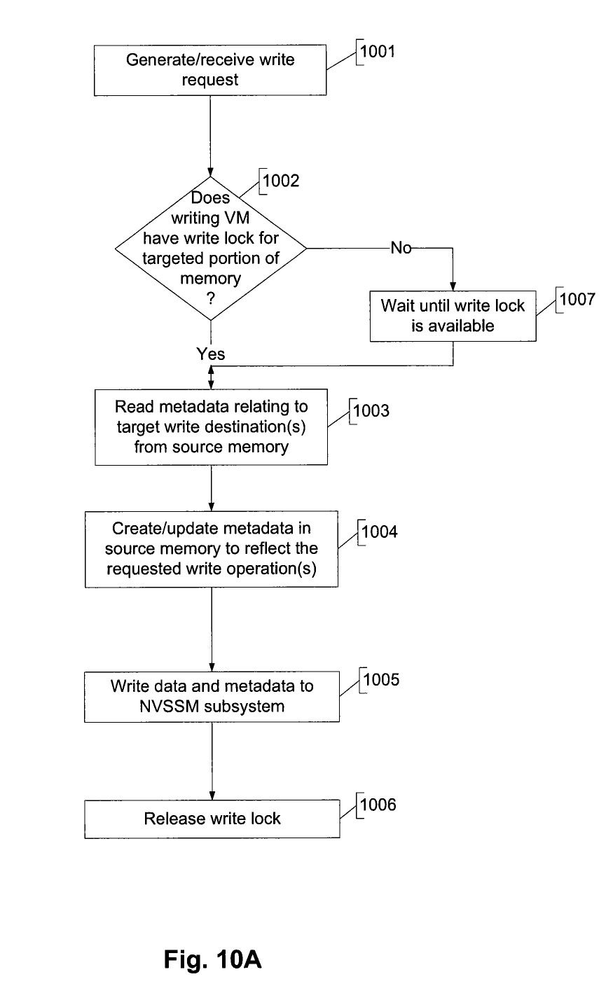

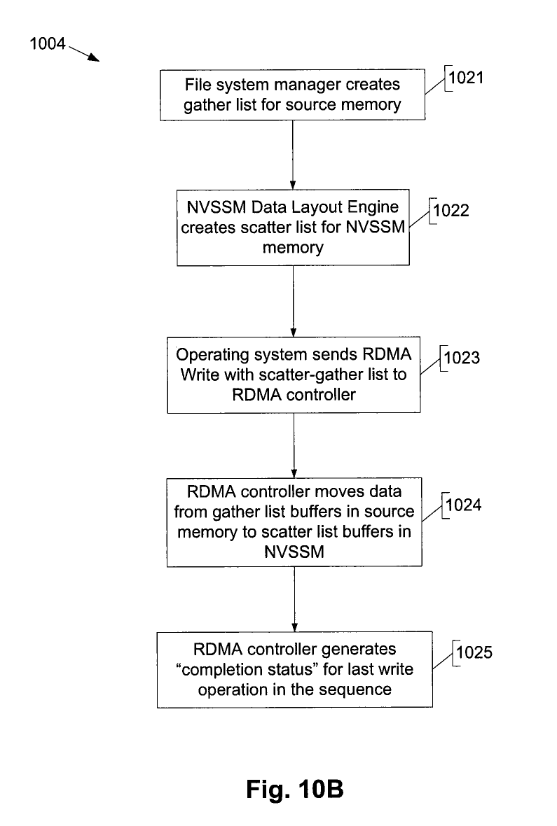

FIGS. 10A and 10B illustrate an example of a write process that can be performed in the processing system 2. FIG. 10A illustrates the overall process, while FIG. 10B illustrates a portion of that process in greater detail. Referring first to FIG. 10A, initially the processing system 2 generates one or more write requests at 1001. The write request(s) may be generated by, for example, an application running within the processing system 2 or by an external application. As noted above, multiple write requests can be combined within the processing system 2 into a single (compound) RDMA write.

Next, at 1002 the virtual machine (“VM”) determines whether it has a write lock (write ownership) for the targeted portion of memory in the NVSSM subsystem 26. If it does have write lock for that portion, the process continues to 1003. If not, the process continues to 1007, which is discussed below.

At 1003, the file system manager 41 (FIG. 4) in the processing system 2 then reads metadata relating to the target destinations for the write data (e.g., the volume(s) and directory or directories where the data is to be written). The file system manager 41 then creates and/or updates metadata in main memory (e.g., memory 22) to reflect the requested write operation(s) at 1004. At 1005 the operating system 40 causes data and associated metadata to be written to the NVSSM subsystem 26. At 1006 the process releases the write lock from the writing virtual machine.

If, at 1002, the write is for a portion of memory (i.e. NVSSM subsystem 26) that is shared between multiple virtual machines 4, and the writing virtual machine does not have write lock for that portion of memory, then at 1007 the process waits until the write lock for that portion of memory is available to that virtual machine, and then proceeds to 1003 as discussed above.

The write lock can be implemented by using an RDMA atomic operation to the memory in the NVSSM subsystem 26. The semantic and control of the shared memory accesses follow the hypervisor's shared memory semantic, which in turn may be the same as the virtual machines' semantic. Thus, when a virtual machine acquires the write lock and when it releases it can be is defined by the hypervisor using standard operating system calls.

FIG. 10B shows in greater detail an example of operation 1004, i.e., the process of executing an RDMA write to transfer data and metadata from memory in the processing system 2 to memory in the NVSSM subsystem 26. Initially, at 1021 the file system manager 41 creates a gather list specifying the locations in host memory (e.g., in memory 22) where the data and metadata to be transferred reside. At 1022 the NVSSM data layout engine 13 (FIG. 1B) creates a scatter list for the locations in the NVSSM subsystem 26 to which the data and metadata are to be written. At 1023 the operating system 40 sends an RDMA Write operation with the scatter-gather list to the RDMA controller (which in the embodiment of FIGS. 2A and 3A is the host RDMA controller 25 or in the embodiment of FIGS. 2B and 3B is the storage RDMA controller 29). At 1024 the RDMA controller moves data and metadata from the buffers in memory 22 specified by the gather list to the buffers in NVSSM memory specified by the scatter list. This operation can be a compound RDMA write, executed as multiple individual writes at the NVSSM subsystem 26, as described above. At 1025, the RDMA controller sends a “completion” status message to the operating system 40 for the last write operation in the sequence (assuming a compound RDMA write), to complete the process. In another embodiment a sequence of RDMA write operations 1004 is generated by the processing system 2. For such an embodiment the completion status is generated only for the last RDMA write operation in the sequence if all previous write operations in the sequence are successful.

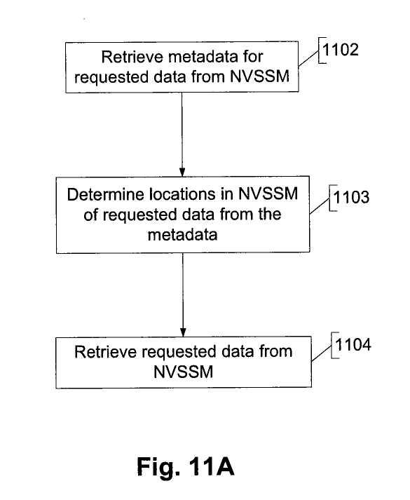

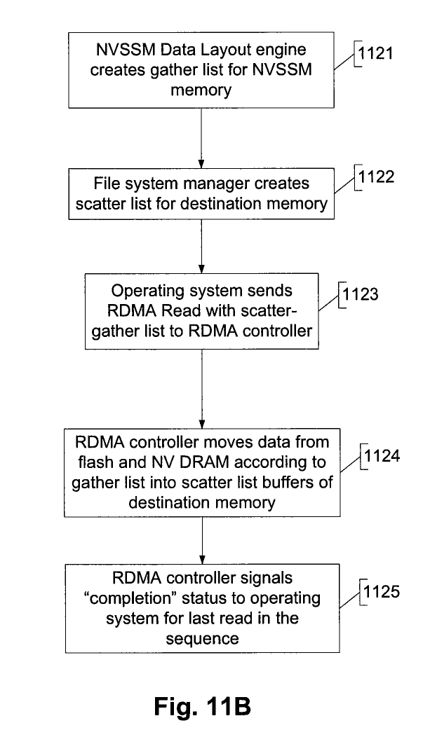

FIGS. 11A and 11B illustrate an example of a read process that can be performed in the processing system 2. FIG. 11A illustrates the overall process, while FIG. 11B illustrates portions of that process in greater detail. Referring first to FIG. 11A, initially the processing system 2 generates or receives one or more read requests at 1101. The read request(s) may be generated by, for example, an application running within the processing system 2 or by an external application. As noted above, multiple read requests can be combined into a single (compound) RDMA read. At 1102 the operating system 40 in the processing system 2 retrieves file system metadata relating to the requested data from the NVSSM subsystem 26; this operation can include a compound RDMA read, as described above. This file system metadata is then used to determine the locations of the requested data in the NVSSM subsystem at 1103. At 1104 the operating system 40 retrieves the requested data from those locations in the NVSSM subsystem at 1104; this operation also can include a compound RDMA read. At 1105 the operating system 40 provides the retrieved data to the requester.

FIG. 11B shows in greater detail an example of operation 1102 or operation 1104, i.e., the process of executing an RDMA read, to transfer data or metadata from memory in the NVSSM subsystem 26 to memory in the processing system 2. In the read case, the processing system 2 first reads metadata for the target data, and then reads the target data based on the metadata, as described above in relation to FIG. 11A. Accordingly, the following process actually occurs twice in the overall process, first for the metadata and then for the actual target data. To simplify explanation, the following description only refers to “data”, although it will be understood that the process can also be applied in essentially the same manner to metadata.

Initially, at 1121 the NVSSM data layout engine 13 creates a gather list specifying locations in the NVSSM subsystem 26 where the data to be read resides. At 1122 the file system manager 41 creates a scatter list specifying locations in host memory (e.g., memory 22) to which the read data is to be written. At 1123 the operating system 40 sends an RDMA Read operation with the scatter-gather list to the RDMA controller (which in the embodiment of FIGS. 2A and 3A is the host RDMA controller 25 or in the embodiment of FIGS. 2B and 3B is the storage RDMA controller 29). At 1124 the RDMA controller moves data from flash memory and non-volatile DRAM 28 in the NVSSM subsystem 26 according to the gather list, into scatter list buffers of the processing system host memory. This operation can be a compound RDMA read, executed as multiple individual reads at the NVSSM subsystem 26, as described above. At 1125 the RDMA controller signals “completion” status to the operating system 40 for the last read in the sequence (assuming a compound RDMA read). In another embodiment a sequence of RDMA read operations 1102 or 1104 is generated by the processing system 2. For such an embodiment the completion status is generated only for the last RDMA Read operation in the sequence if all previous read operations in the sequence are successful. The operating system 40 then sends the requested data to the requester at 1126, to complete the process.

It will be recognized that the techniques introduced above have a number of possible advantages. One is that the use of an RDMA semantic to provide virtual machine fault isolation improves performance and reduces the complexity of the hypervisor for fault isolation support. It also provides support for virtual machines' bypassing the hypervisor completely, thus further improving performance and reducing overhead on the core for “domain 0”, which runs the hypervisor.

Another possible advantage is a performance improvement by combining multiple I/O operations into single RDMA operation. This includes support for data resiliency by supporting multiple data redundancy techniques using RDMA primitives.

Yet another possible advantage is improved support for virtual machine data sharing through the use of RDMA atomic operations. Still another possible advantage is the extension of flash memory (or other NVSSM memory) to support filesystem metadata for a single virtual machine and for shared virtual machine data. Another possible advantage is support for multiple flash devices behind a node supporting virtual machines, by extending the RDMA semantic. Further, the techniques introduced above allow shared and independent NVSSM caches and permanent storage in NVSSM devices under virtual machines.

Thus, a system and method of providing multiple virtual machines with shared access to non-volatile solid-state memory have been described.

The methods and processes introduced above can be implemented in special-purpose hardwired circuitry, in software and/or firmware in conjunction with programmable circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A processing system comprising:
a plurality of virtual machines;
a non-volatile solid-state memory shared by the plurality of virtual machines;
a hypervisor operatively coupled to the plurality of virtual machines; and
a remote direct memory access (RDMA) controller operatively coupled to the plurality of virtual machines and the hypervisor, to access the non-volatile solid-state memory on behalf of the plurality of virtual machines by using RDMA operations.

2. A processing system as recited in claim 1, wherein each of the virtual machines and the hypervisor synchronize write accesses to the non-volatile solid-state memory through the RDMA controller by using atomic memory access operations.

3. A processing system as recited in claim 1, wherein the virtual machines access the non-volatile solid-state memory by communicating with the non-volatile solid-state memory through the RDMA controller without involving the hypervisor.

4. A processing system as recited in claim 1, wherein the hypervisor generates tags to determine a portion of the non-volatile solid-state memory which each of the virtual machines can access.

5. A processing system as recited in claim 4, wherein the hypervisor uses tags to control read and write privileges of the virtual machines to different portions of the non-volatile solid-state memory.

6. A processing system as recited in claim 4, wherein the hypervisor generates the tags to implement load balancing across the non-volatile solid-state memory.

7. A processing system as recited in claim 4, wherein the hypervisor generates the tags to implement fault tolerance between the virtual machines.

8. A processing system as recited in claim 1, wherein the hypervisor implements fault tolerance between the virtual machines by configuring the virtual machines each to have exclusive write access to a separate portion of the non-volatile solid-state memory.

9. A processing system as recited in claim 8, wherein the hypervisor has read access to the portions of the non-volatile solid-state memory to which the virtual machines have exclusive write access.

10. A processing system as recited in claim 1, wherein the non-volatile solid-state memory comprises non-volatile random access memory and a second form of non-volatile solid-state memory; and
wherein, when writing data to the non-volatile solid-state memory, the RDMA controller stores in the non-volatile random access memory, metadata associated with data being stored in the second form of non-volatile solid-state memory.

11. A processing system as recited in claim 1, further comprising a second memory;
wherein the RDMA controller uses scatter-gather lists of the non-volatile solid-state memory and the second memory to perform an RDMA data transfer between the non-volatile solid-state memory and the second memory.

12. A processing system as recited in claim 1, wherein the RDMA controller combines a plurality of write requests from one or more of the virtual machines into a single RDMA write targeted to the non-volatile solid-state memory, wherein the single RDMA write is executed at the non-volatile solid-state memory as a plurality of individual writes.

13. A processing system as recited in claim 12, wherein the RDMA controller suppresses completion status indications for individual ones of the plurality of RDMA writes, and generates only a single completion status indication after the plurality of individual writes have completed successfully.

14. A processing system as recited in claim 13, wherein the non-volatile solid-state memory comprises a plurality of erase blocks, wherein the single RDMA write affects at least one erase block of the non-volatile solid-state memory, and wherein the RDMA controller combines the plurality of write requests so that the single RDMA write substantially fills each erase block affected by the single RDMA write.

15. A processing system as recited in claim 1, wherein the RDMA controller initiates an RDMA write targeted to the non-volatile solid-state memory, the RDMA write comprising a plurality of sets of data, including:
write data,
resiliency metadata associated with the write data, and
file system metadata associated with the client write data;
and wherein the RDMA write causes the plurality of sets of data to be written into different sections of the non-volatile solid-state memory according to an RDMA scatter list generated by the RDMA controller.

16. A processing system as recited in claim 15, wherein the different sections include a plurality of different types of non-volatile solid-state memory.

17. A processing system as recited in claim 16, wherein the plurality of different types include flash memory and non-volatile random access memory.

18. A processing system as recited in claim 17, wherein the RDMA write causes the client write data and the resiliency metadata to be stored in the flash memory and causes the other metadata to be stored in the non-volatile random access memory.

19. A processing system as recited in claim 1, wherein the RDMA controller combines a plurality of read requests from one or more of the virtual machines into a single RDMA read targeted to the non-volatile solid-state memory.

20. A processing system as recited in claim 19, wherein the single RDMA read is executed at the non-volatile solid-state memory as a plurality of individual reads.

21. A processing system as recited in claim 1, wherein the RDMA controller uses RDMA to read data from the non-volatile solid-state memory in response to a request from one of the virtual machines, including generating, from the read request, an RDMA read with a gather list specifying different subsets of the non-volatile solid-state memory as read sources.

22. A processing system as recited in claim 21, wherein at least two of the different subsets are different types of non-volatile solid-state memory.

23. A processing system as recited in claim 22, wherein the different types of non-volatile solid-state memory include flash memory and non-volatile random access memory.

24. A processing system as recited in claim 1, wherein the non-volatile solid-state memory comprises a plurality of memory devices, and wherein the RDMA controller uses RDMA to implement a RAID redundancy scheme to distribute data for a single RDMA write across the plurality of memory devices.

25. A processing system as recited in claim 24, wherein the RAID redundancy scheme is transparent to each of the virtual machines.

26. A processing system comprising:
a plurality of virtual machines;
a non-volatile solid-state memory;
a second memory;
a hypervisor operatively coupled to the plurality of virtual machines, to configure the virtual machines to have exclusive write access each to a separate portion of the non-volatile solid-state memory, wherein the hypervisor has at least read access to each said portion of the non-volatile solid-state memory, and wherein the hypervisor generates tags, for use by the virtual machines, to control which portion of the non-volatile solid-state memory each of the virtual machines can access; and
a remote direct memory access (RDMA) controller operatively coupled to the plurality of virtual machines and the hypervisor, to access the non-volatile solid-state memory on behalf of each of the virtual machines, by creating scatter-gather lists associated with the non-volatile solid-state memory and the second memory to perform an RDMA data transfer between the non-volatile solid-state memory and the second memory, wherein the virtual machines access the non-volatile solid-state memory by communicating with the non-volatile solid-state memory through the RDMA controller without involving the hypervisor.

27. A processing system as recited in claim 26, wherein the hypervisor uses RDMA tags to control access privileges of the virtual machines to different portions of the non-volatile solid-state memory.

28. A processing system as recited in claim 26, wherein the non-volatile solid-state memory comprises non-volatile random access memory and a second form of non-volatile solid-state memory; and
wherein, when writing data to the non-volatile solid-state memory, the RDMA controller stores in the non-volatile random access memory, metadata associated with data being stored in the second form of non-volatile solid-state memory.

29. A processing system as recited in claim 26, wherein the RDMA controller combines a plurality of write requests from one or more of the virtual machines into a single RDMA write targeted to the non-volatile solid-state memory, wherein the single RDMA write is executed at the non-volatile solid-state memory as a plurality of individual writes.

30. A processing system as recited in claim 26, wherein the RDMA controller uses RDMA to read data from the non-volatile solid-state memory in response to a request from one of the virtual machines, including generating, from the read request, an RDMA read with a gather list specifying different subsets of the non-volatile solid-state memory as read sources.

31. A processing system as recited in claim 30, wherein at least two of the different subsets are different types of non-volatile solid-state memory.

32. A method comprising:
operating a plurality of virtual machines in a processing system; and
using remote direct memory access (RDMA) to enable the plurality of virtual machines to have shared access to a non-volatile solid-state memory, including using RDMA to implement fault tolerance between the virtual machines in relation to the non-volatile solid-state memory.

33. A method as recited in claim 32, wherein using RDMA to implement fault tolerance between the virtual machines comprises using a hypervisor to configure the virtual machines to have exclusive write access each to a separate portion of the non-volatile solid-state memory.

34. A method as recited in claim 33, wherein the virtual machines access the non-volatile solid-state memory without involving the hypervisor in accessing the non-volatile solid-state memory.

35. A method as recited in claim 33, wherein using a hypervisor comprises the hypervisor generating tags to determine a portion of the non-volatile solid-state memory which each of the virtual machines can access and to control read and write privileges of the virtual machines to different portions of the non-volatile solid-state memory.

36. A method as recited in claim 32, wherein said using RDMA operations further comprises using RDMA to implement at least one of:
wear-leveling across the non-volatile solid-state memory;
load balancing across the non-volatile solid-state memory; or

37. A method as recited in claim 32, wherein said using RDMA operations comprises:
combining a plurality of write requests from one or more of the virtual machines into a single RDMA write targeted to the non-volatile solid-state memory, wherein the single RDMA write is executed at the non-volatile solid-state memory as a plurality of individual writes.

38. A method as recited in claim 32, wherein said using RDMA operations comprises:
using RDMA to read data from the non-volatile solid-state memory in response to a request from one of the virtual machines, including generating, from the read request, an RDMA read with a gather list specifying different subsets of the non-volatile solid-state memory as read sources.

39. A method as recited in claim 38, wherein at least two of the different subsets are different types of non-volatile solid-state memory.

40. A method as recited in claim 32, wherein the non-volatile solid-state memory comprises a plurality of memory devices, and wherein using RDMA to implement fault tolerance comprises:
using RDMA to implement a RAID redundancy scheme which is transparent to each of the virtual machines to distribute data for a single RDMA write across the plurality of memory devices of the non-volatile solid-state memory.
